(19) United States
(12) Patent Application Publication
(10) Pub. No.: US 2006/0022501 A1
(43) Pub. Date: Feb. 2, 2006

(54) Tilt control structure for chair

(76) Inventor: Yu-Hong Lin, Chayi (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/909,649

(22) Filed: Aug. 2, 2004

(51) Int. Cl. B60N 2/02

(52) U.S. Cl. 297/366

(57) ABSTRACT

A tilt control structure for controlling the tilt angle of the back of a chair is disclosed to include a positioning unit affixed to the back of the chair, a control unit affixed the to seat of the chair and pivoted to the positioning unit, the control unit having an engagement block for engaging the positioning unit to lock the back of the chair, an actuating block coupled to the engagement block through a spring member, and an operating handle turnable between a first position where the spring member is forced by the actuating block to move the engagement block into engagement with the positioning unit and a second position where the spring member is reversed to disengage the engagement from the positioning unit.

### BACKGROUND OF THE INVENTION

1. Field of the Invention

The present invention relates to a tilt control structure for controlling the tilt angle of the back of a chair and more particularly, to such a tilt control structure for chair, which is easy to operate and inexpensive to manufacture.

2. Description of the Related Art

A chair is generally provided with a back for supporting the back of the user sitting on the chair. The back of a chair may be made adjustable, so that the user can adjust the back of the chair to the desired comfortable supporting angle. Taiwan patent publication no. 389066 discloses a safety arrangement to prevent reverse bonding of the back of a chair. This design of safety arrangement comprises a base frame 5 affixed to the bottom side of the back of the chair, a support unit 6 connected to an air cylinder. The base frame 5 has a locating block 54. The locating block 54 has a plurality of locating grooves 55 at different elevations. The support unit 6 comprises an accommodating frame 62, a slide 64, a spring 65, a link 67, an angled swivel member 68, and a push bar 69. The accommodating frame 62 defines therein a sliding way 623 for accommodating the slide 64. The spring 65 has one end connected to the slide 64 and the other end connected to the link 67. The angled swivel member 68 has one end coupled to the link 67 and the other end coupled to the push bar 69. When pushing the push bar 69 to turn the angled swivel member 68, the link 67 is forced by the angled swivel member 68 to move the spring 65, and therefore the slide 64 is forced by the spring 65 into engagement with one locating groove 55 of the locating block 54 and to further lock the back of the chair. When wishing to adjust the tilt angle of the back of the chair, pull the push bar 69.

The design of the aforesaid safety arrangement is still not satisfactory in function. This design is complicated to install because it uses a big number of component parts and a big number of screws to connect the component parts to one another. When locking the back of the chair, the user must push the push bar 69 into the inside of the support unit 6. Further, the user must pull the push bar 69 outwards from the support unit 6 before adjusting the tilt angle of the back of the chair. It is inconvenient to push or pull the push bar 69 relative to the support unit 6. When operating the push bar 69, the user may be unable to keep the body in balance. Therefore, the user must hold the chair with one hand and then push or pull the push bar 69 with the other hand.

### SUMMARY OF THE INVENTION

The present invention has been accomplished under the circumstances in view. It is one object of the present invention to provide a tilt control structure for chair, which enables the user to adjust the tilt angle of the back of the chair conveniently with one single hand. It is another object of the present invention to provide a tilt control structure for chair, which is inexpensive to manufacture and easy to install. It is still another object of the present invention to provide a tilt control structure for chair, which is safe in use.

To achieve these and other objects of the present invention, the tilt control structure is installed in a chair having a seat and a back and adapted to control the tilt angle of the back of the chair, comprising: a positioning unit fixedly fastened to the back of the chair, the positioning unit having a plurality of vertically spaced locating grooves; and a control unit fixedly fastened to the seat of the chair and pivoted to the positioning unit, the control unit comprising a casing pivoted to the positioning unit, an engagement block movable in the casing and adapted to engage one locating groove of the positioning unit to lock the positioning unit to the control unit, an actuating block, a spring member coupled between the actuating block and the engagement block, and an operating handle pivoted to the casing and turnable relative to the casing between a first position where the operating handle engages the actuating block and the spring member is forced by the actuating block to force the engagement block into engagement with one locating groove of the positioning unit to lock the positioning unit to the control unit, and a second position where the operating handle disengages the actuating block and the spring member is reversed to disengage the engagement block from the locating grooves of the positioning unit and to further unlock the positioning unit from the control unit.

### BRIEF DESCRIPTION OF THE DRAWINGS

FIG. 1 is a perspective view of a tilt control structure according to the present invention.

FIG. 2 is an exploded view of the tilt control structure according to the present invention.

FIG. 3 is a sectional side view of the tilt control structure according to the present invention.

FIG. 4 is a sectional front view of the present invention, showing the operating handle in the second position.

FIG. 5 is a top view showing the movable engagement block disengaged from the stem of the positioning unit.

FIG. 6 is a sectional side view of the present invention showing the back of the office chair unlocked.

FIG. 7 is a sectional front view of the present invention showing the operating handle in the first position.

FIG. 8 is a top view of the present invention showing the movable engagement block engaged with one locating groove of the stem of the positioning unit.

FIG. 9 is a sectional side view of the present invention showing the back of the office chair locked.

### DETAILED DESCRIPTION OF THE PREFERRED EMBODIMENT

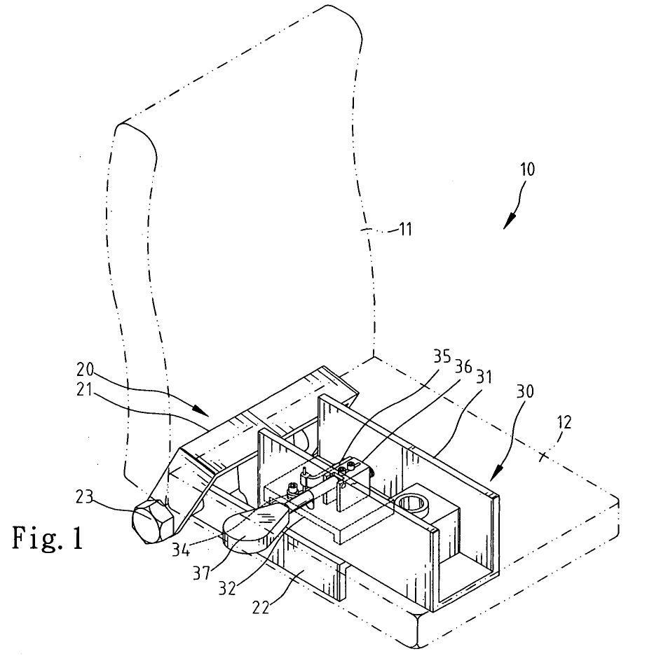

Referring to FIG. 1, a tilt control structure is installed in an office chair 10 below the seat 12 for controlling the tilt angle of the back 11 of the office chair 10. The tilt control structure comprises a positioning unit 20 and a control unit 30. The positioning unit 20 is affixed to the bottom side of the back 11. The control unit 30 is coupled to the positioning unit 20, having an operating handle 37 turnable between a first position and a second position to control the tilt angle of the back 11.

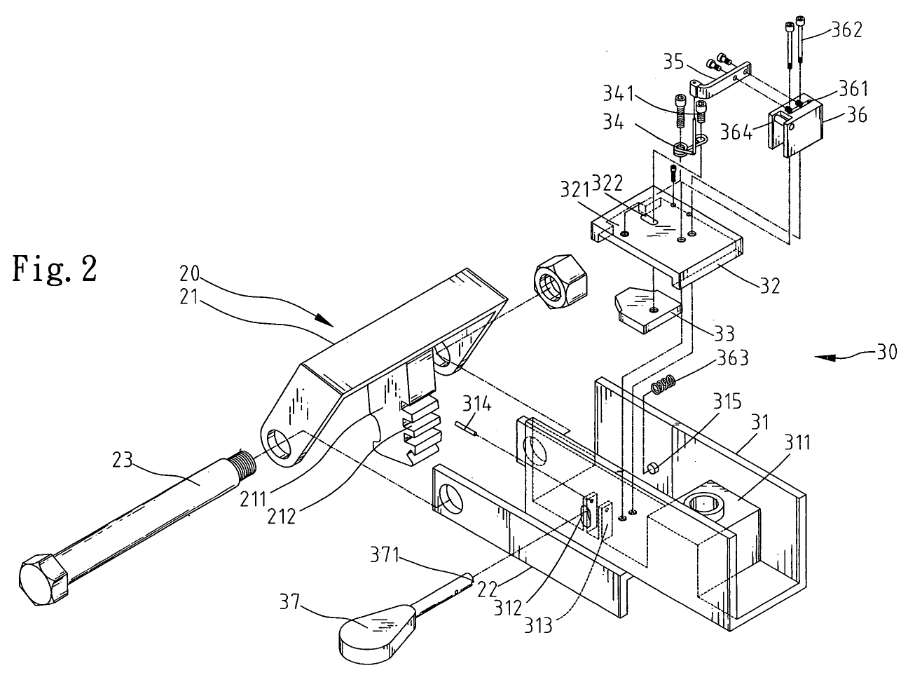

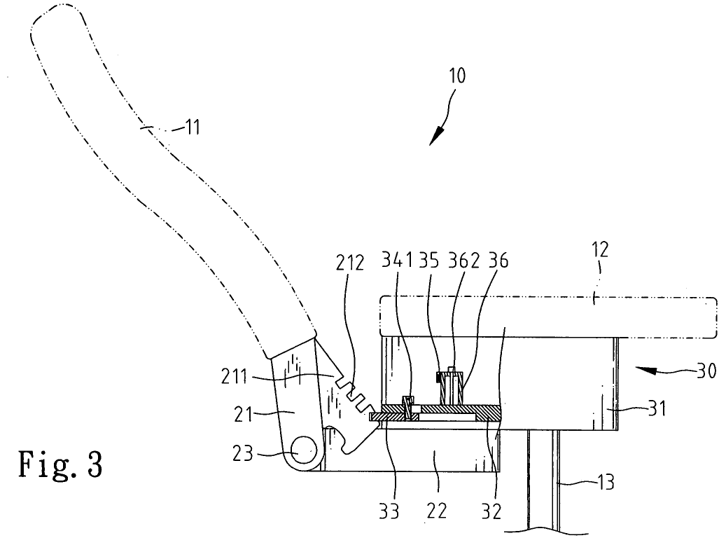

Referring to FIGS. 2 and 3 and FIG. 1 again, the positioning unit 20 comprises a mounting frame 21 and a connecting frame 22. The mounting frame 21 is fixedly fastened to the bottom side of the back 11, having a downwardly extended stem 211. The stem 211 has a plurality of vertically spaced locating grooves 212 for controlling the positioning of the control unit 30. The connecting frame 22 has a front end pivotally connected to the mounting frame 21 by a pivot bolt 23, and a rear end fixedly fastened to the control unit 30.

The control unit 30 is mounted in between the seat 12 and stand 13 of the office chair 10, comprising a casing 31, a locating block 32, a movable engagement block 33, a spring member 34, a link 35, an actuating block 36, and the aforesaid operating handle 37. The casing 31 is fixedly fastened to the bottom side of the seat 12, having a first end fastened to the rear end of the connecting frame 22 of the positioning unit 20 and a second end fastened to a movable block 311 at the stand 13 of the office chair 10. The casing 31 is shaped like a channel bar having an opening 312 in one sidewall thereof, two lugs 313 at two sides of the opening 312, and a stub rod 315 protruded from the inner side of the other sidewall thereof. The locating block 32 is fixedly mounted inside the casing 31 near the connecting frame 22, having a bottom sliding way 321 facing the connecting frame 22 and a top sliding slot 322 in communication with the bottom sliding way 321. The movable engagement block 33 is slidably mounted in the sliding way 321 and adapted to engage one of the locating grooves 212 of the stem 211 of the mounting frame 21 of the positioning unit 20. The spring member 34 is mounted on the locating block 32, having a first end mounted with a screw 341, which is inserted through the top sliding slot 322 and fastened to the movable engagement block 33 and a second end connected to one end of the link 35. The link 35 has one end connected to the spring member 34 and the other end affixed to the actuating block 36. The actuating block 36 is provided inside the casing 31 between the lugs 313 and the stub rod 315, having a top sliding slot 361. Two screws 362 are inserted through the top sliding slot 361 of the actuating block 36 and fastened to the locating block 32 to limit horizontal movement of the actuating block 36 between the lugs 313 and the stub rod 315. A compression spring 363 is supported between one lateral side of the actuating block 36 and the stub rod 315 of the casing 31. The actuating block 36 further has a transverse stop rod 364 at one lateral side corresponding to the lugs 313 for stopping the operating handle 31. The operating handle 31 is inserted through the opening 312 and pivotally connected between the lugs 313 by a pivot pin 314, having a smoothly arched engagement portion 371 in one end for receiving the stop rod 354 of the actuating block 36. The operating handle 37 is turnable about the pivot pin 314 between a first position and a second position. When the operating handle 37 is in the first position, the stop rod 364 is maintained engaged with the smoothly arched engagement portion 371 of the operating handle 37 to lock the back 11 of the office chair 10.

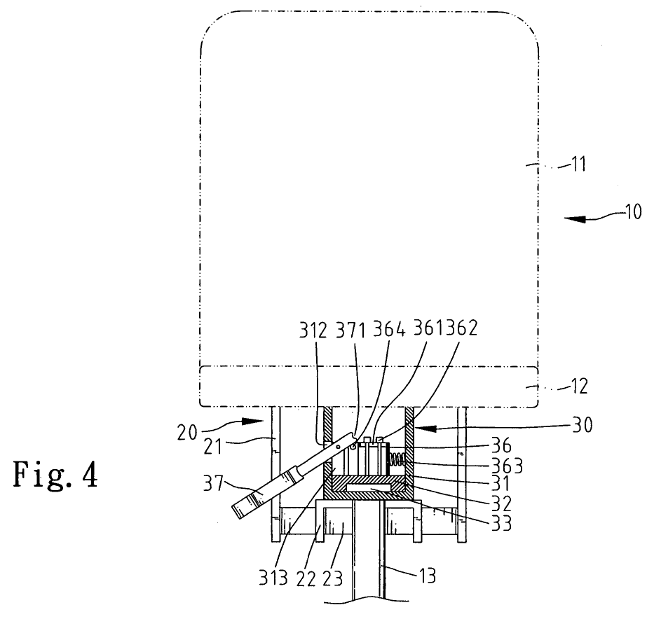

Referring to FIG. 4, when wishing to adjust the tilt angle of the back 11 of the office chair 10, turn the operating handle 37 about the pivot pin 314 from the first position to the second position to disengage the smoothly arched engagement portion 371 from the stop rod 364 of the actuating block 36. After disengagement of the stop rod 364 from the smoothly arched engagement portion 371 of the operating handle 37, the compression spring 363 is released to force the actuating block 36 toward the lugs 313.

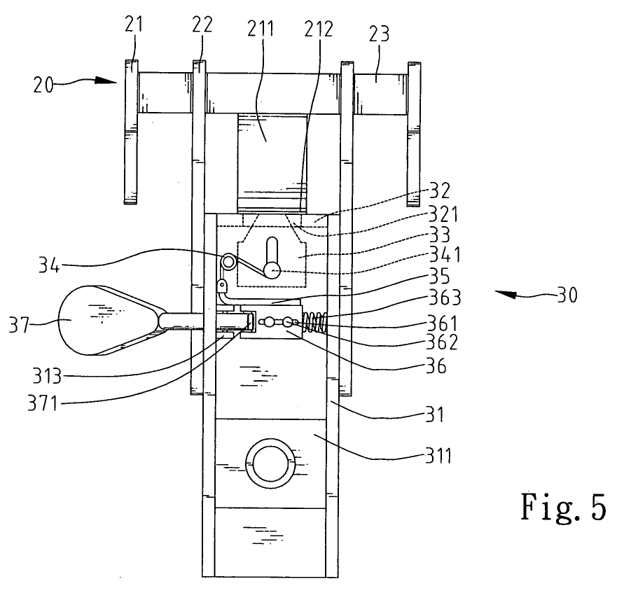

Referring to FIG. 5, when the actuating block 36 is moved to the lugs 313, the link 35 is simultaneously forced to move the spring member 34, thereby causing the spring member 34 to pull the movable engagement block 33 away from the locating grooves 212 of the positioning unit 20.

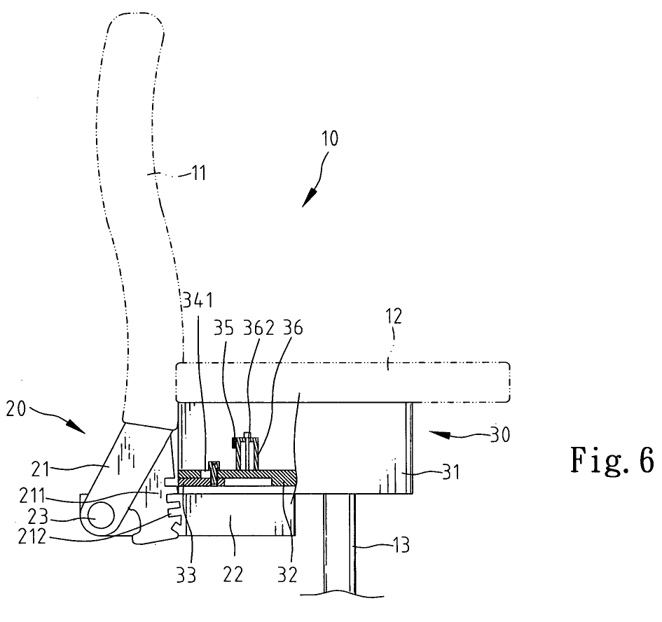

Referring to FIG. 6, after disengagement of the movable engagement block 33 from the locating grooves 212 of the positioning unit 20, the back 11 of the office chair 10 is unlocked, and the user can freely adjust the tilt angle of the back 11.

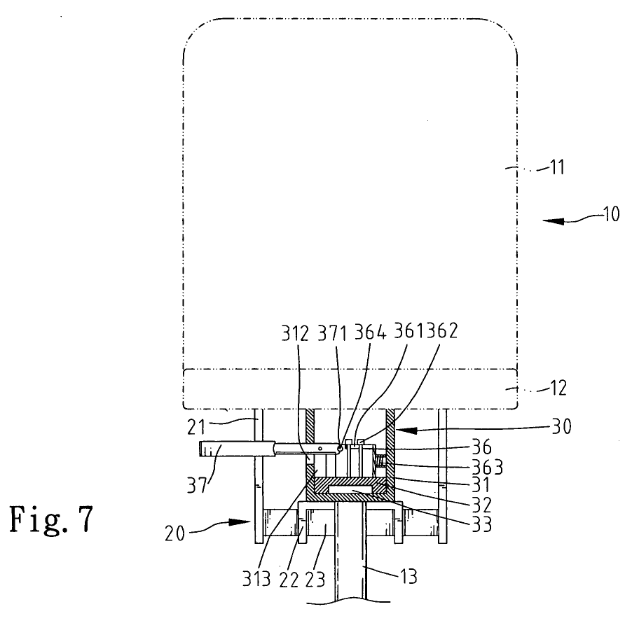

Referring to FIG. 7, after the back 11 has been adjusted to the desired tilt angle, turn the operating handle 37 about the pivot pin 314 from the second position to the first position to force the smoothly arched engagement portion 371 of the operating handle 37 into engagement with the stop rod 364 of the actuating block 36. After engagement between the smoothly arched engagement portion 371 of the operating handle 37 and the stop rod 364 of the actuating block 36, the compression spring 363 is compressed to impart a pressure to the actuating block 36 against the operating handle 37, and therefore the engagement between the smoothly arched engagement portion 371 of the operating handle 37 and the stop rod 364 of the actuating block 36 is assured.

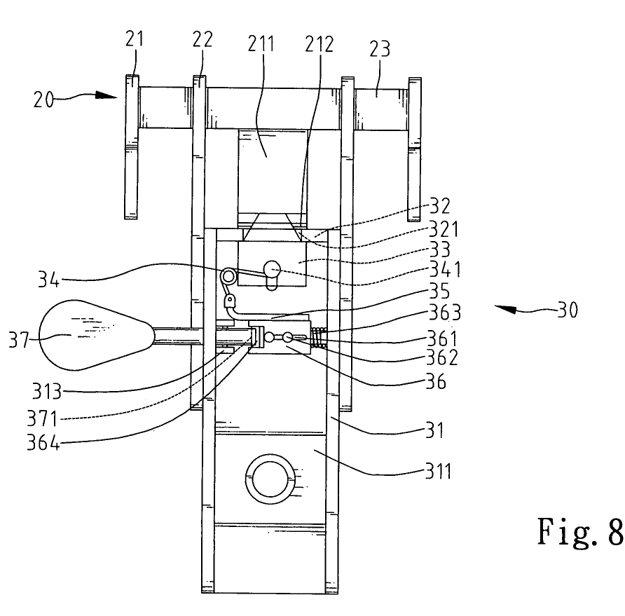

Referring to FIG. 8, when turning the operating handle 37 about the pivot pin 314 from the second position to the first position to force the smoothly arched engagement portion 371 of the operating handle 37 into engagement with the stop rod 364 of the actuating block 36, the actuating block 36 will be moved toward the stub rod 315, and the link 35 will be forced to move the spring member 34 in the reversed direction to further move the sliding engagement block 33 into engagement with one locating groove 212 of the positioning unit 20 to lock the back 11 of the office chair 10 to the seat 12 at the desired tilt angle.

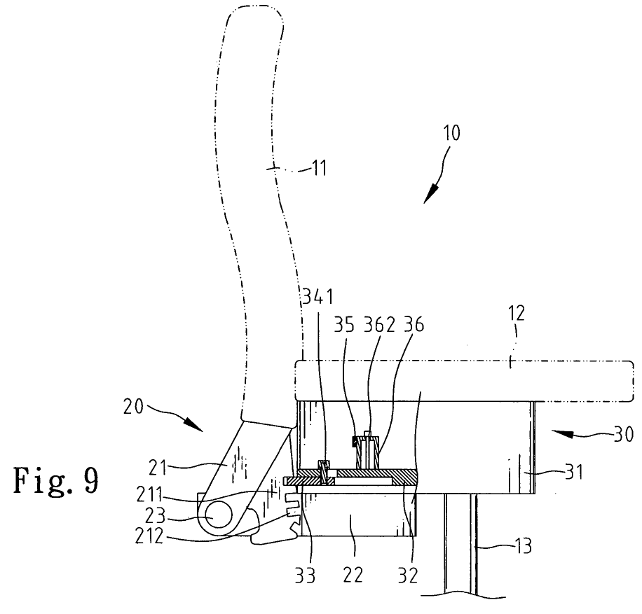

Referring to FIG. 9, after engagement of the movable engagement block 33 with one locating groove 212 of the positioning unit 20, the back 11 and the positioning unit 20 are locked, providing a comfortable tilt angle to support the user's back.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A tilt control structure installed in a chair having a seat and a back and adapted to control the tilt angle of said back of said chair, the tilt control structure comprising:
a positioning unit fixedly fastened to said back of said chair, said positioning unit having a plurality of vertically spaced locating grooves; and
a control unit fixedly fastened to said seat of said chair and pivoted to said positioning unit, said control unit comprising a casing pivoted to said positioning unit, an engagement block movable in said casing and adapted to engage one locating groove of said positioning unit to lock said positioning unit to said control unit, an actuating block, a spring member coupled between said actuating block and said engagement block, and an operating handle pivoted to said casing and turnable relative to said casing between a first position where said operating handle engages said actuating block and said spring member is forced by said actuating block to force said engagement block into engagement with one locating groove of said positioning unit to lock said positioning unit to said control unit, and a second position where said operating handle disengages said actuating block and said spring member is reversed to disengage said engagement block from the locating grooves of said positioning unit and to further unlock said positioning unit from said control unit.

2. The tilt control structure as claimed in claim 1, wherein said operating handle has a smoothly arched engagement portion in one end thereof for engaging said actuating block.

3. The tilt control structure as claimed in claim 2, wherein said actuating block comprises a stop rod for receiving the smoothly arched engagement portion of said operating handle.

4. The tilt control structure as claimed in claim 3, wherein said casing comprises an upright screw; said actuating block has a sliding slot coupled to said upright screw inside said casing.

5. The tilt control structure as claimed in claim 4, further comprising a spring member supported between one side of said casing and one side of said actuating block and adapted to force said actuating block toward said operating handle.

6. The tilt control structure as claimed in claim 1, wherein said casing comprises at least one lug; said operating handle is pivotally connected to said at least one lug of said casing by a pivot pin.

7. The tilt control structure as claimed in claim 1, wherein said control unit further comprises a locating block fixedly mounted inside said casing and defining a sliding way for accommodating said engagement block.
